(19) United States
(12) Patent Application Publication
(10) Pub. No.: US 2026/0316526 A1
(43) Pub. Date: Oct. 15, 2026

(54) VEHICLE VENT MECHANISM CONTROLLED USING SHAPE MEMORY ALLOY ACTUATOR

(71) Applicant: Atieva, Inc., Newark, CA (US)

(72) Inventors: Michael Davis Jacobs, Redwood City, CA (US); Amol Nakul Sonaje, Sunnyvale, CA (US)

(21) Appl. No.: 19/175,544

(22) Filed: Apr. 10, 2025

(51) Int. Cl. B60H 1/34

(52) U.S. Cl. CPC B60H 1/3421; B60H 2001/3471

(57) ABSTRACT

A vent mechanism comprises: vent vanes to direct airflow from a duct, each being mounted to the vent mechanism for rotation about respective rotation axes that are parallel with each other; a ratchet wheel to control the rotation of the vent vanes, the ratchet wheel being mounted to the vent mechanism for rotation about a rotation axis that is parallel with the rotation axes of the vent vanes; a first shape memory alloy wire having a first end and a second end, the first end attached to a first nonmoving portion of the vent mechanism; and a first moveable member attached to the second end of the first shape memory alloy wire for engaging with at least a first set of teeth of the ratchet wheel to rotate the ratchet wheel in a first direction in response to shortening of the first shape memory alloy wire.

### TECHNICAL FIELD

This document relates to a vehicle vent mechanism controlled using a shape memory alloy actuator.

### BACKGROUND

Many vehicles use a heating, ventilation, and air conditioning (HVAC) unit (or a heating, dehumidification, and air conditioning (HDAC) unit) to circulate air for the passenger cabin. One or more vents connected to the air duct(s) of the HVAC unit can be positioned in the passenger cabin to distribute the air. To direct the airflow from the vent, either manually controlled mechanisms or servo motors have been used. With manual control, an occupant either slides or twists a knob or lever of the vent to adjust its vanes and thereby reposition the airflow stream. These approaches do not provide a way for a vehicle controller to regulate the airflow.

In recent years, small servo motors (e.g., stepper motors) have been used with vents in some vehicles to automate the realignment of the vanes (whether located at the air vent exit or inside the ducting and thermal routing system). However, the servo motors increase the material cost and the weight of the vehicle. Moreover, these approaches may require extensive packaging space within the vehicle (e.g., near the vent within an instrument panel or a console) and may be associated with unwanted noise from the servo motors.

### SUMMARY

In a first aspect, a vent mechanism comprises: vent vanes configured to direct airflow from a duct, each of the vent vanes being mounted to the vent mechanism for rotation about respective rotation axes that are parallel with each other; a ratchet wheel configured to control the rotation of the vent vanes, the ratchet wheel being mounted to the vent mechanism for rotation about a rotation axis that is parallel with the rotation axes of the vent vanes; a first shape memory alloy wire having a first end and a second end, the first end attached to a first nonmoving portion of the vent mechanism; and a first moveable member attached to the second end of the first shape memory alloy wire, the first moveable member configured for engaging with at least a first set of teeth of the ratchet wheel to rotate the ratchet wheel in a first direction in response to shortening of the first shape memory alloy wire.

Implementations can include any or all of the following features. The ratchet wheel is configured to control the rotation of the vent vanes by way of a first vent vane of the vent vanes being attached to the ratchet wheel for rotation with the ratchet wheel, the vent mechanism further including a linkage connected to each of the vent vanes to rotate remaining ones of the vent vanes due to the rotation of the one of the first vent vane. The vent vanes are arranged in a row. The first vent vane is positioned outermost in the row of the vent vanes. The first moveable member includes: a first arm having a first end and a second end, the first end rotatably attached to a second nonmoving portion of the vent mechanism, the second end attached to the second end of the first shape memory alloy wire; and a first drive pawl rotatably attached to the first arm, wherein the first drive pawl is configured for engaging with at least the first set of teeth of the ratchet wheel to rotate the ratchet wheel in the first direction in response to shortening of the first shape memory alloy wire. The vent mechanism further comprises a first bias member attached to the first arm, the first bias member biasing the first drive pawl toward the first arm. The vent mechanism further comprises a first end stop attached to the first arm, the first end stop defining an end of rotation for the first drive pawl. The vent mechanism further comprises a first bias member attached to the second end of the first arm, the first bias member biasing the first arm in a direction opposite to a direction of the shortening of the first shape memory alloy wire. Each of the first set of teeth of the ratchet wheel has a driving face to be engaged by the first drive pawl to rotate the ratchet wheel in the first direction, and a nondriving face, and wherein an angle between the driving face and a radius of the ratchet wheel is smaller than an angle between the nondriving face and the radius of the ratchet wheel. The vent mechanism further comprises a detent lock biased toward the ratchet wheel from a third nonmoving portion of the vent mechanism. The vent mechanism further comprises: a first mechanism coupled to the drive pawl to release the drive pawl from the teeth of the ratchet wheel in response to the ratchet wheel reaching the end of rotation; a locking pawl configured for engaging with at least the first set of teeth of the ratchet wheel; a second mechanism coupled to the locking pawl to release the locking pawl from the teeth of the ratchet wheel in response to the ratchet wheel reaching the end of rotation; and a torsion spring configured to rotate the ratchet wheel when the moveable member and the locking pawl are released from the teeth of the ratchet wheel. The vent mechanism further comprises: a second shape memory alloy wire having a first end and a second end, the first end attached to a second nonmoving portion of the vent mechanism; and a second moveable member attached to the second end of the second shape memory alloy wire, the second moveable member configured for engaging with at least a second set of teeth of the ratchet wheel to rotate the ratchet wheel in a second direction in response to shortening of the second shape memory alloy wire, the second direction opposite to the first direction. The second moveable member includes: a second arm having a first end and a second end, the first end rotatably attached to a third nonmoving portion of the vent mechanism, the second end attached to the second end of the second shape memory alloy wire; and a second drive pawl rotatably attached to the second arm, wherein the second drive pawl is configured for engaging with at least the second set of teeth of the ratchet wheel to rotate the ratchet wheel in the second direction in response to shortening of the second shape memory alloy wire. The vent mechanism further comprises a second bias member attached to the second arm, second first bias member biasing the second drive pawl toward the second arm. The vent mechanism further comprises a second end stop attached to the second arm, the second end stop defining an end of rotation for the second drive pawl. The vent mechanism further comprises a second bias member attached to the second end of the second arm, the second bias member biasing the second arm in a direction opposite to a direction of the shortening of the second shape memory alloy wire. Each of the second set of teeth of the ratchet wheel has a driving face to be engaged by the second drive pawl to rotate the ratchet wheel in the second direction, and a nondriving face, and wherein an angle between the driving face and a radius of the ratchet wheel is smaller than an angle between the nondriving face and the radius of the ratchet wheel. The first moveable member includes: a first linear actuator having a first end and a second end, the first end attached to the second end of the first shape memory alloy wire, the first linear actuator including first teeth to engage with at least the first set of teeth of the ratchet wheel; and a first bias member attached to the second end of the first linear actuator and biasing the first linear actuator in a direction opposite to a direction of the shortening of the first shape memory alloy wire. Each of the first teeth of the first linear actuator has a driving face to engage the first set of teeth of the ratchet wheel to rotate the ratchet wheel in the first direction, and a nondriving face, wherein the driving face is perpendicular to a direction of travel of the first linear actuator, and wherein the nondriving face is non-perpendicular to the direction of travel. Each of the first set of teeth of the ratchet wheel has a driving face to be engaged by the first teeth of the first linear actuator to rotate the ratchet wheel in the first direction, and a nondriving face, and wherein an angle between the driving face and a radius of the ratchet wheel is equal to an angle between the nondriving face and the radius of the ratchet wheel. Each of the first set of teeth of the ratchet wheel has a driving face to be engaged by the first teeth of the first linear actuator to rotate the ratchet wheel in the first direction, and a nondriving face, and wherein an angle between the driving face and a radius of the ratchet wheel is smaller than an angle between the nondriving face and the radius of the ratchet wheel. The vent mechanism further comprises: a second shape memory alloy wire having a first end and a second end, the first end attached to a second nonmoving portion of the vent mechanism; and a second moveable member attached to the second end of the second shape memory alloy wire, the second moveable member configured for engaging with at least a second set of teeth of the ratchet wheel to rotate the ratchet wheel in a second direction in response to shortening of the second shape memory alloy wire, the second direction opposite to the first direction. The second moveable member includes: a second linear actuator having a first end and a second end, the first end attached to the second end of the second shape memory alloy wire, the second linear actuator including second teeth to engage with at least the second set of teeth of the ratchet wheel; and a second bias member attached to the second end of the second linear actuator and biasing the second linear actuator in a direction opposite to a direction of the shortening of the second shape memory alloy wire. Each of the second teeth of the second linear actuator has a driving face to engage the second set of teeth of the ratchet wheel to rotate the ratchet wheel in the second direction, and a nondriving face, wherein the driving face is perpendicular to a direction of travel of the second linear actuator, and wherein the nondriving face is non-perpendicular to the direction of travel. Each of the second set of teeth of the ratchet wheel has a driving face to be engaged by the second teeth of the second linear actuator to rotate the ratchet wheel in the second direction, and a nondriving face, and wherein an angle between the driving face and a radius of the ratchet wheel is equal to an angle between the nondriving face and the radius of the ratchet wheel. Each of the second set of teeth of the ratchet wheel has a driving face to be engaged by the second teeth of the second linear actuator to rotate the ratchet wheel in the second direction, and a nondriving face, and wherein an angle between the driving face and a radius of the ratchet wheel is smaller than an angle between the nondriving face and the radius of the ratchet wheel. The vent mechanism further comprises a detent lock biased toward the first set of teeth of the ratchet wheel from a third nonmoving portion of the vent mechanism. The vent mechanism further comprises: a locking pawl configured for engaging with at least the first set of teeth of the ratchet wheel; a mechanism coupled to the locking pawl to release the locking pawl from the teeth of the ratchet wheel in response to the ratchet wheel reaching the end of rotation; and a torsion spring configured to rotate the ratchet wheel when the moveable member and the locking pawl are released from the teeth of the ratchet wheel.

In a second aspect, a vehicle comprises: an air circulation unit; a duct that conveys airflow from the air circulation unit; and a first vent mechanism comprising: vent vanes configured to direct the airflow from the duct, each of the vent vanes being mounted to the first vent mechanism for rotation about respective rotation axes that are parallel with each other; a ratchet wheel configured to control the rotation of the vent vanes, the ratchet wheel being mounted to the first vent mechanism for rotation about a rotation axis that is parallel with the rotation axes of the vent vanes; a shape memory alloy wire having a first end and a second end, the first end attached to a first nonmoving portion of the first vent mechanism; and a moveable member attached to the second end of the shape memory alloy wire, the moveable member configured for engaging with at least a set of teeth of the ratchet wheel to rotate the ratchet wheel in response to shortening of the shape memory alloy wire.

Implementations can include any or all of the following features. The vehicle further comprises a controller implemented using circuitry. The controller is configured to apply current to the shape memory alloy wire to rotate the ratchet wheel. The controller is configured to use a thermoelectric device to change a temperature of the shape memory alloy wire to rotate the ratchet wheel. The first vent mechanism controls an inlet to a passenger cabin of the vehicle, wherein the controller is user operable to regulate the airflow in the passenger cabin. The controller is user operable to regulate the airflow in at least a left-right direction. The controller is user operable to regulate the airflow in at least an up-down direction. The controller controls the airflow to at least a first zone and a second zone of a passenger cabin of the vehicle. The vehicle further comprises a second vent mechanism, wherein the controller controls both the first and second vent mechanisms.

### BRIEF DESCRIPTION OF DRAWINGS

FIG. 1 shows an example of a vent mechanism with dual drive.

FIG. 2 shows an example of a vent mechanism with single drive and auto reset.

FIG. 3 shows another example of a vent mechanism with dual drive.

FIG. 4 shows another example of a vent mechanism with dual drive.

FIG. 5 shows another example of a vent mechanism with single drive and auto reset.

FIG. 6 schematically shows an example of a vehicle that has vent mechanisms according to the present subject matter and an air circulation unit.

Like reference symbols in the various drawings indicate like elements.

### DETAILED DESCRIPTION

This document describes examples of systems and techniques for using a shape memory alloy actuator to control a vehicle vent mechanism having different states that include a progressive range of setting positions. That is, the present subject matter can discretize the motion of the vent mechanism for multi-step actuation. Implementations of the present subject matter can provide automated vent mechanism control at a lower cost and weight than servo motors. Also or instead, implementations of the present subject matter can be packaged in a tighter space than a servo motor, can allow partial relocation of mechanism features from the vanes and the hot/cold air, and can operate quieter than servo motors. Some examples illustrated herein show only selected portions of a given structure for clarity; that is, some structures or features may have been omitted in the drawings to clarify the illustration. In this detailed description, elements have reference numbers in three-digit series where the first of the digits indicates the number of the figure where the element is introduced.

The present subject matter can use shape memory alloy wires to actuate vane motion changes. Shape memory alloy wires upon actuation only provide motion in line with the wire routing, so additional hardware is provided to convert this linear motion to rotary output. Shape memory alloy wires experience continual expansion or contraction in response to a thermal change like all materials, but are tuned to create a large strain response over a relatively small temperature (shown as stress) delta. In practice this yields actuation in discrete distances, so the air vent adjustment is discretized into a number of zones or positions. Using more zones will increase precision and increase adjustment time for larger angle change requirements. The vent mechanism can be controlled automatically (e.g., a system controls the vent mechanism without human input), or semi-automatically (e.g., a human makes an input to a controller that in turn controls the vent mechanism), or manually (e.g., a human activates an electric switch that causes the temperature of the shape memory alloy wire to change).

Some implementations use a single shape memory alloy actuator to control both directions of one axis of movement (either left/right or up/down). In these implementations, motion in one direction (e.g., counter-clockwise) must finish to reset the actuation to the clockwise start point. Other implementations use two shape memory alloy actuators to permit adjusting in both directions. Further implementations connect multiple axes (such as left/right and up/down) into one sequential series of positions controlled by one actuator. For example, this can increase response speed in adjusting the positions of the vanes.

As used herein, a shape memory alloy means an alloy that can exist in at least two different phases depending on temperature. A shape memory alloy can include, but is not limited to, a copper-aluminum-nickel alloy or a nickel-titanium alloy. The wire's temperature can be increased by running electrical current through the wire in a closed loop or by otherwise changing the temperature of the wire. As current runs, the internal wire resistance causes temperature increases, with a strain change similarly occurring due to the material's properties. Minimal strain changes occur until the phase transformation points (at a defined lower temperature), followed by a large strain change of loading that is the functional adjustment area, that then terminates again afterwards at a defined higher temperature, all in a small temperature range. The input power is then cut, temperature decreases, and the pattern occurs in reverse to reset the wire to original conditions. With nickel-titanium alloys this strain change can be used to create a shrinking/pulling motion of great effect (e.g., about 10%) over a narrow temperature range (e.g., about 10 degrees C). The desired wire shape when heated is known as the memorized geometry and can be set during production by a thermal treatment, enabling freedom to choose the needed wire position for a specific usage. In addition, the desired actuation motion can be controlled by adjusting the initial wire length. In addition, the desired actuation force can be controlled by adjusting the initial wire diameter. Alternative chemical compositions of the wire can also drive impacts to these inputs. Alternative methods of heating (or cooling) the wire can be performed without running current through, such as mounting the wire on a thermoelectric device, remotely changing the temperature of the ambient air around the wire, or other heat transfer method.

As used herein, a vehicle is a machine that transports passengers or cargo, or both. A vehicle can have one or more motors. Examples of vehicles include, but are not limited to, cars, trucks, buses, motorcycles, and scooters. The number of wheels can differ between types of vehicles, and one or more (e.g., all) of the wheels can be used for propulsion of the vehicle. The vehicle can include a passenger compartment accommodating one or more persons.

As used herein, an air circulation unit means at least one of an HVAC or an HDAC.

Examples described herein refer to a top, bottom, front, or rear, or to a direction as being clockwise or counterclockwise. These and similar expressions identify things or aspects or movement in a relative way based on an express or arbitrary notion of perspective. That is, these terms are illustrative only, used for purposes of explanation, and do not necessarily indicate the only possible position, direction, and so on.

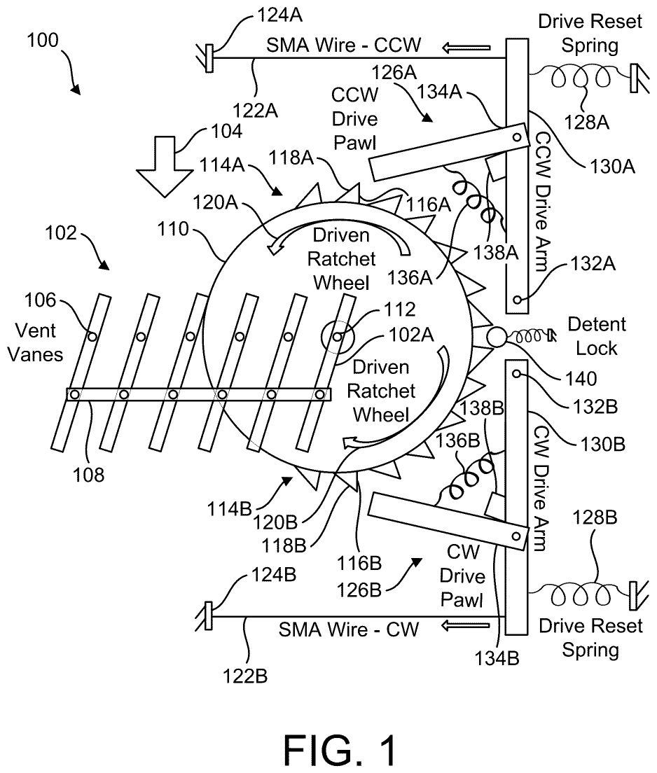

FIG. 1 shows an example of a vent mechanism 100 with dual drive. The vent mechanism 100 can be used with one or more other examples described elsewhere herein. The vent mechanism 100 includes vent vanes 102 configured to direct airflow 104 from a duct. The airflow 104 is here schematically illustrated as an arrow oriented top-down in the plane of the drawing. The vent mechanism 100 can include N number of the vent vanes 102, where N=1, 2, 3, . . . . Here, six of the vent vanes 102 are shown as an example. Each of the vent vanes 102 is mounted to the vent mechanism 100 for rotation about respective rotation axes 106 that are parallel with each other. The rotation adjusts the position of the vent vanes 102 to any of a progressive range of discrete states for controlling the airflow 104. For example, the orientation of the vent vanes 102 can control a left-right direction of the airflow 104. As another example, the orientation of the vent vanes 102 can control an up-down direction of the airflow 104. Other approaches can be used. Here, the vent vanes 102 are arranged in a row. In this example, the vent vanes 102 are all identical to each other and their respective rotation axes 106 are here aligned with each other in the row. The vent mechanism 100 includes a linkage 108 connected to each of the vent vanes 102 at respective pivots. As such, the orientations of the vent vanes 102 can be synchronized.

The vent mechanism 100 includes a ratchet wheel 110 configured to control the rotation of the vent vanes 102. The ratchet wheel 110 is mounted to the vent mechanism 100 for rotation about a rotation axis 112. The rotation axis 112 is parallel with each of the respective rotation axes 106 of the vent vanes 102. The ratchet wheel 110 can be configured to control the rotation of the vent vanes 102 by way of at least one of the vent vanes being attached to the ratchet wheel 110 for rotation with the ratchet wheel 110. Here, a vent vane 102A of the vent vanes 102 is attached to the ratchet wheel 110. The rotation axis 106 of the vent vane 102A therefore coincides with the rotation axis 112 of the ratchet wheel 110. Because the vent vane 102A is attached to the ratchet wheel 110, rotation of the ratchet wheel 110 causes rotation of remaining ones of the vent vanes 102 through the linkage 108. Any of the vent vanes 102 can be the vent vane 102A that is attached to the ratchet wheel 110. Here, the vent vane 102A is positioned outermost in the row of the vent vanes 102.

The ratchet wheel 110 includes at least a set 114A of teeth having a first profile. Each of the teeth of the set 114A has a driving face 116A and a nondriving face 118A. The driving face 116A is to be engaged with in rotating the ratchet wheel ratchet wheel 110 in a direction 120A. For example, the direction 120A can be characterized as a counter-clockwise (CCW) direction. Here, the driving face 116A forms a first angle with a radius of the ratchet wheel 110. Likewise, the nondriving face 118A forms a second angle with the radius of the ratchet wheel 110. Here, the first angle is smaller than the second angle.

The vent mechanism 100 includes a shape memory alloy wire 122A having a first end attached to a nonmoving portion 124A of the vent mechanism 100. For example, the nonmoving portion 124A can be any portion of the vent mechanism 100 that does not rotate or otherwise move as a result of the rotation of the ratchet wheel 110 or the vent vanes 102. The shape memory alloy wire 122A will shorten in response to a temperature change, for example by an electric current being run through the shape memory alloy wire 122A to heat it, or by effectuating a thermal change using a thermoelectric device.

A second end of the shape memory alloy wire 122A, opposite to the first end, is here attached to a moveable member 126A of the vent mechanism 100. The moveable member 126A is to be moved due to the shortening of the shape memory alloy wire 122A. The moveable member 126A is configured for engaging with at least the set 114A of teeth of the ratchet wheel 110 to rotate the ratchet wheel 110 in the direction 120A in response to shortening of the shape memory alloy wire 122A. The vent mechanism 100 here includes a bias member 128A (e.g., an extension spring) connected to the moveable member 126A and to a nonmoving portion of the vent mechanism 100. The bias member 128A will bias the moveable member 126A in a direction opposite to a direction of the shortening of the shape memory alloy wire 122A.

In some implementations, the moveable member 126A includes an arm 130A having a first end and a second end. The first end of the arm 130A is here rotatably attached to a nonmoving portion of the vent mechanism at a pivot 132A. The second end of the arm 130A is here attached to the second end of the shape memory alloy wire 122A. The moveable member 126A here also includes a drive pawl 134A rotatably attached to the arm 130A. The drive pawl 134A is configured for engaging with at least the set 114A of teeth of the ratchet wheel 110 (particularly, with the driving faces 116A thereof) to rotate the ratchet wheel in the direction 120A in response to shortening of the shape memory alloy wire 122A. The moveable member 126A can include a bias member 136A (e.g., an extension spring) connected to the arm 130A to bias the drive pawl 134A toward the arm 130A. The moveable member 126A can include an end stop 138A attached to the arm 130A, the end stop 138A defining an end of rotation for the drive pawl 134A.

The vent mechanism 100 can include a detent lock 140 biased toward the ratchet wheel 110 from a nonmoving portion of the vent mechanism 100. For example, a compression spring can be attached between the detent lock 140 and the nonmoving portion.

The ratchet wheel 110 includes at least a set 114B of teeth having a second profile different from the first profile of the set 114A. Each of the teeth of the set 114B has a driving face 116B and a nondriving face 118B. The driving face 116B is to be engaged with in rotating the ratchet wheel ratchet wheel 110 in a direction 120B. For example, the direction 120B can be characterized as a clockwise (CW) direction. Here, the driving face 116B forms a first angle with a radius of the ratchet wheel 110. Likewise, the nondriving face 118B forms a second angle with the radius of the ratchet wheel 110. Here, the first angle is smaller than the second angle.

The vent mechanism 100 includes a shape memory alloy wire 122B having a first end attached to a nonmoving portion 124B of the vent mechanism 100. For example, the nonmoving portion 124B can be any portion of the vent mechanism 100 that does not rotate or otherwise move as a result of the rotation of the ratchet wheel 110 or the vent vanes 102. The shape memory alloy wire 122B will shorten in response to a temperature change, for example by an electric current being run through the shape memory alloy wire 122B to heat it, or by effectuating a thermal change using a thermoelectric device.

A second end of the shape memory alloy wire 122B, opposite to the first end, is here attached to a moveable member 126B of the vent mechanism 100. The moveable member 126B is to be moved due to the shortening of the shape memory alloy wire 122B. The moveable member 126B is configured for engaging with at least the set 114B of teeth of the ratchet wheel 110 to rotate the ratchet wheel 110 in the direction 120B in response to shortening of the shape memory alloy wire 122B. The vent mechanism 100 here includes a bias member 128B (e.g., an extension spring) connected to the moveable member 126B and to a nonmoving portion of the vent mechanism 100. The bias member 128B will bias the moveable member 126B in a direction opposite to a direction of the shortening of the shape memory alloy wire 122B.

In some implementations, the moveable member 126B includes an arm 130B having a first end and a second end. The first end of the arm 130B is here rotatably attached to a nonmoving portion of the vent mechanism at a pivot 132B. The second end of the arm 130B is here attached to the second end of the shape memory alloy wire 122B. The moveable member 126B here also includes a drive pawl 134B rotatably attached to the arm 130B. The drive pawl 134B is configured for engaging with at least the set 114B of teeth of the ratchet wheel 110 (particularly, with the driving faces 116B thereof) to rotate the ratchet wheel in the direction 120B in response to shortening of the shape memory alloy wire 122B. The moveable member 126B can include a bias member 136B (e.g., an extension spring) connected to the arm 130B to bias the drive pawl 134B toward the arm 130B. The moveable member 126B can include an end stop 138B attached to the arm 130B, the end stop 138B defining an end of rotation for the drive pawl 134B.

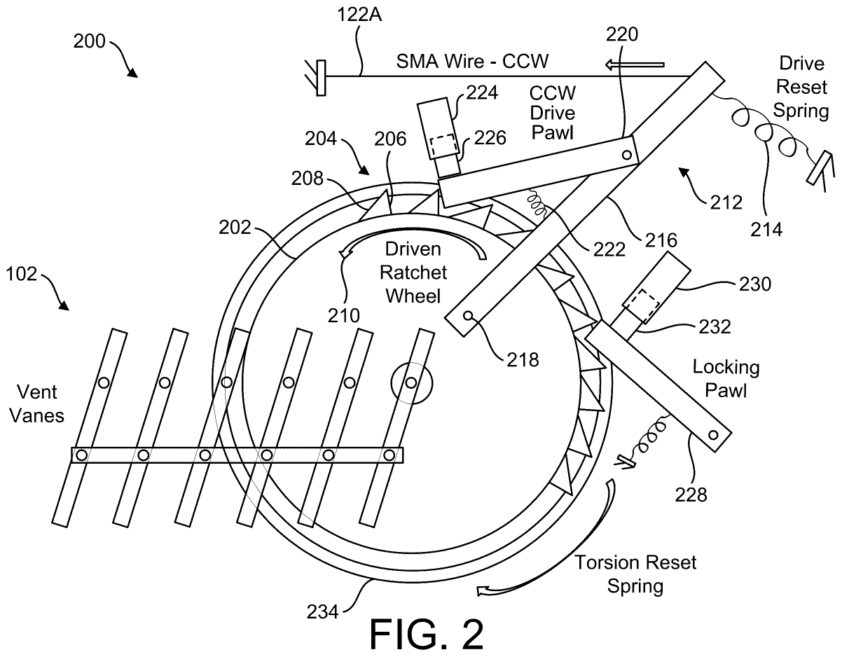

FIG. 2 shows an example of a vent mechanism 200 with single drive and auto reset. The vent mechanism 200 can be used with one or more other examples described elsewhere herein. Some aspects that are similar or identical to those of the vent mechanism 100 of FIG. 1 will not be described in detail. For example, the vent mechanism 200 can include the vent vanes 102 and the shape memory alloy wire 122A of FIG. 1.

The vent mechanism 200 includes a ratchet wheel 202 configured to control the rotation of the vent vanes 102. The ratchet wheel 202 includes at least a set 204 of teeth. Each of the teeth of the set 204 has a driving face 206 and a nondriving face 208. The driving face 206 is to be engaged with in rotating the ratchet wheel 202 in a direction 210. For example, the direction 210 can be characterized as a counter-clockwise direction. Here, the driving face 206 forms a first angle with a radius of the ratchet wheel 202. Likewise, the nondriving face 208 forms a second angle with the radius of the ratchet wheel 202. Here, the first angle is smaller than the second angle.

An end of the shape memory alloy wire 122A is here attached to a moveable member 212 of the vent mechanism 200. The moveable member 212 is to be moved due to the shortening of the shape memory alloy wire 122A. The moveable member 212 is configured for engaging with at least the set 204 of teeth of the ratchet wheel 202 to rotate the ratchet wheel 202 in the direction 210 in response to shortening of the shape memory alloy wire 122A. The vent mechanism 200 here includes a bias member 214 (e.g., an extension spring) connected to the moveable member 212 and to a nonmoving portion of the vent mechanism 200. The bias member 214 will bias the moveable member 212 in a direction opposite to a direction of the shortening of the shape memory alloy wire 122A.

In some implementations, the moveable member 212 includes an arm 216 having a first end and a second end. The first end of the arm 216 is here rotatably attached to a nonmoving portion of the vent mechanism at a pivot 218. That is, the pivot 218 is not formed on the ratchet wheel 202. The second end of the arm 216 is here attached to the second end of the shape memory alloy wire 122A. The moveable member 212 here also includes a drive pawl 220 rotatably attached to the arm 216. The drive pawl 220 is configured for engaging with at least the set 204 of teeth of the ratchet wheel 202 (particularly, with the driving faces 206 thereof) to rotate the ratchet wheel in the direction 210 in response to shortening of the shape memory alloy wire 122A. The moveable member 212 can include a bias member 222 (e.g., an extension spring) connected to the arm 216 to bias the drive pawl 220 toward the arm 216.

The vent mechanism 200 can include a mechanism 224 coupled to the drive pawl 220 to release the drive pawl 220 from the teeth of the ratchet wheel 202 in response to the ratchet wheel 202 reaching the end of rotation. The mechanism 224 can include an actuator (e.g., a linear actuator). For example, a member 226 of the mechanism 224 is coupled to the drive pawl 220 and can be controlled to move the drive pawl 220.

The vent mechanism 200 can include a locking pawl 228 configured for engaging with the set 204 of teeth of the ratchet wheel 202. For example, the locking pawl 228 is rotatably mounted to a nonmoving portion of the vent mechanism 200. The locking pawl 228 can be biased into engagement with the ratchet wheel 202 (e.g., by an extension spring). The vent mechanism 200 can include a mechanism 230 coupled to the locking pawl 228 to release the locking pawl 228 from the teeth of the ratchet wheel 202 in response to the ratchet wheel 202 reaching the end of rotation. The mechanism 230 can include an actuator (e.g., a linear actuator). For example, a member 232 of the mechanism 230 is coupled to the locking pawl 228 and can be controlled to move the locking pawl 228.

The vent mechanism 200 can include a torsion spring 234 configured to rotate the ratchet wheel 202 when the moveable member 212 and the locking pawl 228 are released from the teeth of the ratchet wheel. That is, in operation, the moveable member 212 can cause the ratchet wheel 202 to rotate in the direction 210 in one or more steps (based on actuation by shortening of the shape memory alloy wire 122A). When the moveable member 212 has fully rotated the ratchet wheel 202 (e.g., to a fully CCW position), the mechanisms 224 and 230 can release the drive pawl 220 and the locking pawl 228, respectively, thereby allowing the torsion spring 234 to rotate the ratchet wheel 202 to its end position in the opposite direction (e.g., to a fully CW position).

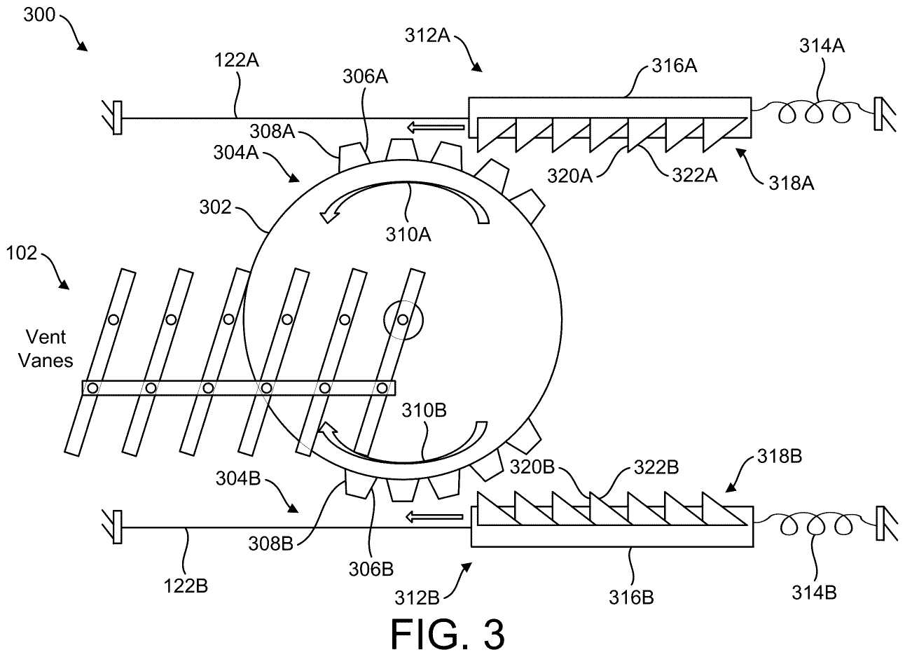

FIG. 3 shows another example of a vent mechanism 300 with dual drive. The vent mechanism 300 can be used with one or more other examples described elsewhere herein. Some aspects that are similar or identical to those of the vent mechanism 100 of FIG. 1 will not be described in detail. For example, the vent mechanism 200 can include the vent vanes 102 and the shape memory alloy wires 122A and 122B of FIG. 1.

The vent mechanism 300 includes a ratchet wheel 302 configured to control the rotation of the vent vanes 102. The ratchet wheel 302 includes at least a set 304A of teeth. Each of the teeth of the set 304A has a driving face 306A and a nondriving face 308A. The driving face 306A is to be engaged with in rotating the ratchet wheel ratchet wheel 302 in a direction 310A. For example, the direction 310A can be characterized as a counter-clockwise direction. Here, the driving face 306A forms a first angle with a radius of the ratchet wheel 302. Likewise, the nondriving face 308A forms a second angle with the radius of the ratchet wheel 302. Here, the first angle is equal to the second angle.

An end of the shape memory alloy wire 122A is here attached to a moveable member 312A of the vent mechanism 300. The moveable member 312A is to be moved due to the shortening of the shape memory alloy wire 122A. The moveable member 312A is configured for engaging with at least the set 304A of teeth of the ratchet wheel 302 to rotate the ratchet wheel 302 in the direction 310A in response to shortening of the shape memory alloy wire 122A. The vent mechanism 300 here includes a bias member 314A (e.g., an extension spring) connected to the moveable member 312A and to a nonmoving portion of the vent mechanism 300. The bias member 314A will bias the moveable member 312A in a direction opposite to a direction of the shortening of the shape memory alloy wire 122A.

In some implementations, the moveable member 312A includes a linear actuator 316A having a first end and a second end, the first end attached to the end of the shape memory alloy wire 122A, the second end attached to the bias member 314A. The linear actuator 316A includes teeth 318A to engage with at least the set 304A of teeth of the ratchet wheel 302. Each of the teeth 318A of the linear actuator 316A has a driving face 320A and a nondriving face 322A. The driving face 320A engages the set 304A of teeth of the ratchet wheel 302 to rotate the ratchet wheel 302 in the direction 310A. The driving face 320A is perpendicular to a direction of travel of the linear actuator 316A. The nondriving face 322A is non-perpendicular to the direction of travel.

The ratchet wheel 302 includes at least a set 304B of teeth. Each of the teeth of the set 304B has a driving face 306B and a nondriving face 308B. The driving face 306B is to be engaged with in rotating the ratchet wheel ratchet wheel 302 in a direction 310B. For example, the direction 310B can be characterized as a clockwise direction. Here, the driving face 306B forms a first angle with a radius of the ratchet wheel 302. Likewise, the nondriving face 308B forms a second angle with the radius of the ratchet wheel 302. Here, the first angle is equal to the second angle.

An end of the shape memory alloy wire 122B is here attached to a moveable member 312B of the vent mechanism 300. The moveable member 312B is to be moved due to the shortening of the shape memory alloy wire 122B. The moveable member 312B is configured for engaging with at least the set 304B of teeth of the ratchet wheel 302 to rotate the ratchet wheel 302 in the direction 310B in response to shortening of the shape memory alloy wire 122B. The vent mechanism 300 here includes a bias member 314B (e.g., an extension spring) connected to the moveable member 312B and to a nonmoving portion of the vent mechanism 300. The bias member 314B will bias the moveable member 312B in a direction opposite to a direction of the shortening of the shape memory alloy wire 122B.

In some implementations, the moveable member 312B includes a linear actuator 316B having a first end and a second end, the first end attached to the end of the shape memory alloy wire 122B, the second end attached to the bias member 314B. The linear actuator 316B includes teeth 318B to engage with at least the set 304B of teeth of the ratchet wheel 302. Each of the teeth 318B of the linear actuator 316B has a driving face 320B and a nondriving face 322B. The driving face 320B engages the set 304B of teeth of the ratchet wheel 302 to rotate the ratchet wheel 302 in the direction 310B. The driving face 320B is perpendicular to a direction of travel of the linear actuator 316B. The nondriving face 322B is non-perpendicular to the direction of travel.

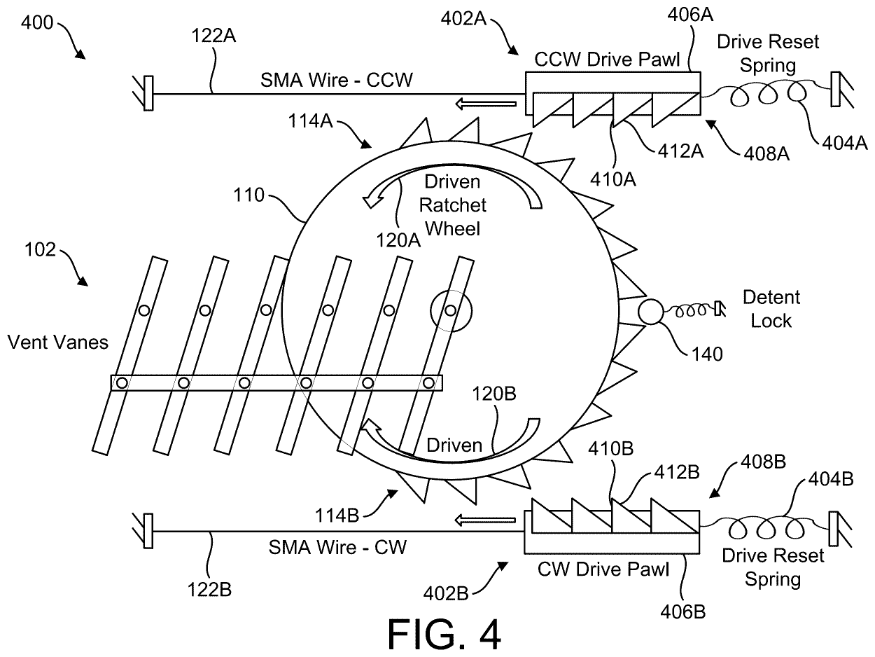

FIG. 4 shows another example of a vent mechanism 400 with dual drive. The vent mechanism 400 can be used with one or more other examples described elsewhere herein. Some aspects that are similar or identical to those of the vent mechanism 100 of FIG. 1 will not be described in detail. For example, the vent mechanism 400 can include the vent vanes 102, the ratchet wheel 110, the shape memory alloy wires 122A and 122B, and the detent lock 140 of FIG. 1.

An end of the shape memory alloy wire 122A is here attached to a moveable member 402A of the vent mechanism 400. The moveable member 402A is to be moved due to the shortening of the shape memory alloy wire 122A. The moveable member 402A is configured for engaging with at least the set 114A of teeth of the ratchet wheel 110 to rotate the ratchet wheel 110 in the direction 120A in response to shortening of the shape memory alloy wire 122A. The vent mechanism 400 here includes a bias member 404A (e.g., an extension spring) connected to the moveable member 402A and to a nonmoving portion of the vent mechanism 400. The bias member 404A will bias the moveable member 402A in a direction opposite to a direction of the shortening of the shape memory alloy wire 122A.

In some implementations, the moveable member 402A includes a linear actuator 406A having a first end and a second end. For example, the linear actuator 406A can be a drive pawl. The first end of the linear actuator 406A can be attached to the end of the shape memory alloy wire 122A. The second end of the linear actuator 406A can be attached to the bias member 404A. The linear actuator 406A includes teeth 408A to engage with at least the set 114A of teeth of the ratchet wheel 110. Each of the teeth 408A of the linear actuator 406A has a driving face 410A and a nondriving face 412A. The driving face 410A engages the set 114A of teeth of the ratchet wheel 110 to rotate the ratchet wheel 110 in the direction 120A. The driving face 410A is perpendicular to a direction of travel of the linear actuator 406A. The nondriving face 412A is non-perpendicular to the direction of travel.

An end of the shape memory alloy wire 122B is here attached to a moveable member 402B of the vent mechanism 400. The moveable member 402B is to be moved due to the shortening of the shape memory alloy wire 122B. The moveable member 402B is configured for engaging with at least the set 114B of teeth of the ratchet wheel 110 to rotate the ratchet wheel 110 in the direction 120B in response to shortening of the shape memory alloy wire 122B. The vent mechanism 400 here includes a bias member 404B (e.g., an extension spring) connected to the moveable member 402B and to a nonmoving portion of the vent mechanism 400. The bias member 404B will bias the moveable member 402B in a direction opposite to a direction of the shortening of the shape memory alloy wire 122B.

In some implementations, the moveable member 402B includes a linear actuator 406B having a first end and a second end. For example, the linear actuator 406B can be a drive pawl. The first end of the linear actuator 406B can be attached to the end of the shape memory alloy wire 122B. The second end of the linear actuator 406B can be attached to the bias member 404B. The linear actuator 406B includes teeth 408B to engage with at least the set 114B of teeth of the ratchet wheel 110. Each of the teeth 408B of the linear actuator 406B has a driving face 410B and a nondriving face 412B. The driving face 410B engages the set 114B of teeth of the ratchet wheel 110 to rotate the ratchet wheel 110 in the direction 120B. The driving face 410B is perpendicular to a direction of travel of the linear actuator 406B. The nondriving face 412B is non-perpendicular to the direction of travel.

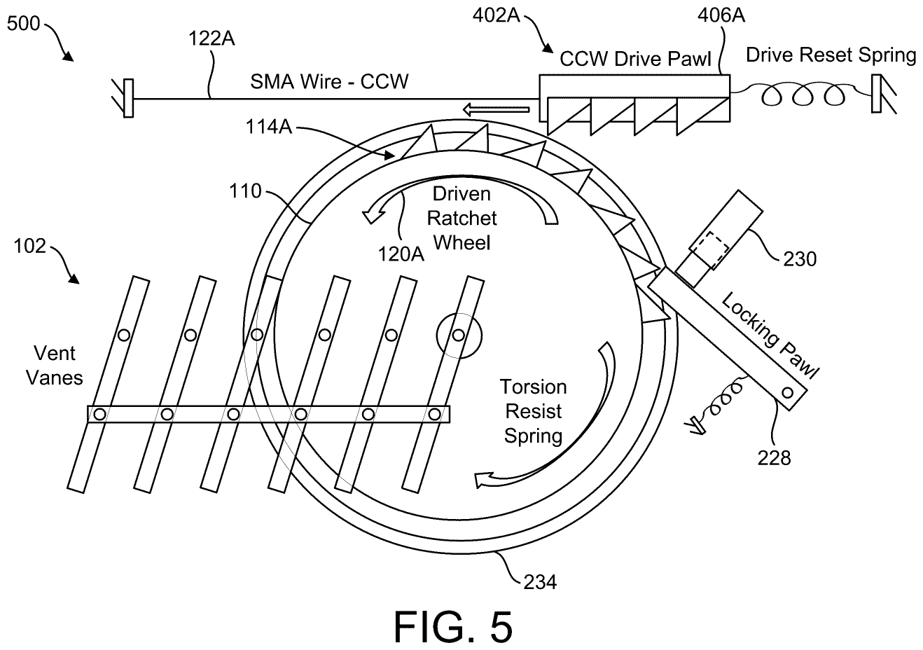

FIG. 5 shows another example of a vent mechanism 500 with single drive and auto reset. The vent mechanism 500 can be used with one or more other examples described elsewhere herein. Some aspects that are similar or identical to those of other examples hereof will not be described in detail. For example, the vent mechanism 500 can include the vent vanes 102; the ratchet wheel 110 having the set 114A of teeth; the shape memory alloy wire 122A of FIG. 1; the locking pawl 228, the mechanism 230; the torsion spring 234 of FIG. 2; and the moveable member 402A of FIG. 4.

The torsion spring 234 is here configured to rotate the ratchet wheel 110 when the locking pawl 228 is released from the teeth of the ratchet wheel 110. That is, in operation, the moveable member 402A (e.g., the linear actuator 406A) can cause the ratchet wheel 110 to rotate in the direction 120A in one or more steps (based on actuation by shortening of the shape memory alloy wire 122A). When the moveable member 402A has fully rotated the ratchet wheel 110 (e.g., to a fully CCW position), the mechanism 230 can release the locking pawl 228, thereby allowing the torsion spring 234 to rotate the ratchet wheel 110 to its end position in the opposite direction (e.g., to a fully CW position).

With reference again briefly to each of FIGS. 1-5, the above examples illustrate that a vent mechanism (e.g., the vent mechanism 100, the vent mechanism 200, the vent mechanism 300, the vent mechanism 400 or the vent mechanism 500) can include: vent vanes (e.g., the vent vanes 102) configured to direct airflow (e.g., the airflow 104) from a duct, each of the vent vanes being mounted to the vent mechanism for rotation about respective rotation axes (e.g., the respective rotation axes 106) that are parallel with each other; a ratchet wheel (e.g., the ratchet wheel 110, the ratchet wheel 202 or the ratchet wheel 302) configured to control the rotation of the vent vanes, the ratchet wheel being mounted to the vent mechanism for rotation about a rotation axis (e.g., the rotation axis 112) that is parallel with the rotation axes of the vent vanes; a first shape memory alloy wire (e.g., the shape memory alloy wire 122A) having a first end and a second end, the first end attached to a first nonmoving portion of the vent mechanism; and a first moveable member (e.g., the moveable member 126A, the moveable member 212, the moveable member 312A, or the moveable member 402A) attached to the second end of the first shape memory alloy wire, the first moveable member configured for engaging with at least a first set of teeth (e.g., the set 114A, the set 204, or the set 304A) of the ratchet wheel to rotate the ratchet wheel in a first direction (e.g., the direction 120A, the direction 210 or the direction 310A) in response to shortening of the first shape memory alloy wire.

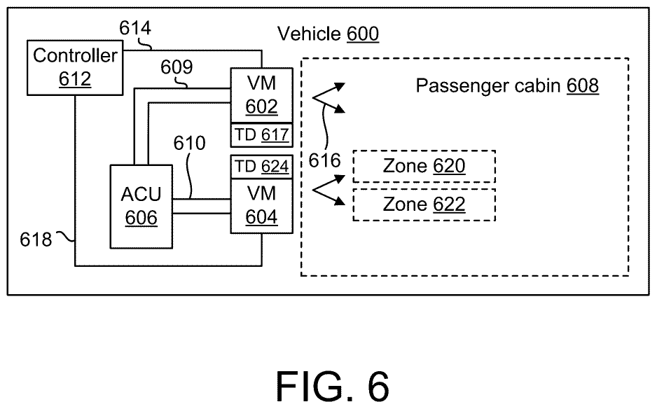

FIG. 6 schematically shows an example of a vehicle 600 that has vent mechanisms (VM) 602 and 604 according to the present subject matter and an air circulation unit (ACU) 606. One or more other examples described elsewhere herein can be used with vehicle 600. Because the vehicle 600 is schematically illustrated, most details such as wheels, powertrain, etc. are omitted.

The air circulation unit 606 can be an HVAC or an HDAC. The air circulation unit 606 is configured for circulating air to a passenger cabin 608 of the vehicle 600, here schematically illustrated using a dashed outline. The air circulation unit 606 has a duct 609 to the vent mechanism 602 so that the vent mechanism 602 can direct the airflow conveyed by the duct 609. The air circulation unit 606 has a duct 610 to the vent mechanism 604 so that the vent mechanism 604 can direct the airflow conveyed by the duct 610. The vent mechanisms 602 and 604 can be used to control airflow anywhere along the path between the air circulation unit 606 and the passenger cabin 608. For example, at least one of the vent mechanisms 602 or 604 can control airflow as the airflow is entering the passenger cabin 608 (e.g., by being positioned in an instrument panel, console or seat of the vehicle). As another example, at least one of the vent mechanisms 602 or 604 can reroute the proportion of air flowing between one duct (e.g., an upper duct) and another duct (e.g., a lower duct) that will then meet at the final exit to create a single angled stream (e.g., if more air is sent in the upper duct than in the lower duct, then this larger stream will blow down at the exit and divert the total air downwards on the occupant).

The vehicle 600 includes a controller 612 that is implemented using circuitry (e.g., the controller 612 can include one or more chips or other integrated circuits). The controller 612 can perform various functions relating to the operation of the vehicle 600 and/or the comfort of its occupants. In some implementations, the controller 612 regulates a thermal system of the vehicle 600 based on at least the air circulation unit 606 and can allow occupants to change settings or other parameters regarding temperature, humidity, and so on. Such user input can be made using any form of HMI including, but not limited to, a touch-sensitive display device of an infotainment system of the vehicle 600.

The controller 612 can control the air circulation unit 606 and the vent mechanisms 602 and 604, optionally together with other components of a thermal system of the vehicle 600. In some implementations, the controller 612 applies current to the vent mechanism 602 to effectuate a temperature change. Here, the controller 612 can use a conductor 614 to run current through a shape memory alloy wire of the vent mechanism 602 to regulate one or more vent vanes thereof. In some implementations, the vent mechanism 602 controls an inlet to the passenger cabin 608, and the controller 612 is user operable to regulate an airflow 616 in the passenger cabin 608. For example, the vent mechanism 602 regulates the airflow 616 in at least a left-right direction. As another example, the vent mechanism 602 regulates the airflow 616 in at least an up-down direction. In other implementations, the controller 612 can use a thermoelectric device (TD) 617 to change the temperature of the shape memory alloy wire of the vent mechanism 602.

In some implementations, the controller 612 applies current to the vent mechanism 604 to effectuate a temperature change. Here, the controller 612 can use a conductor 618 to run current through a shape memory alloy wire of the vent mechanism 604 to regulate one or more vent vanes thereof. In some implementations, the vent mechanism 604 controls the airflow to at least a zone 620 and a zone 622 of the passenger cabin 608. In some implementations, this can allow the controller 612 to use the air circulation unit 606 and the vent mechanism 604 to effectuate thermal multizone routing in the interior of the vehicle 600. In other implementations, the controller 612 can use a thermoelectric device 624 to change the temperature of the shape memory alloy wire of the vent mechanism 604.

The zones 620 and 622 can include any zones of the vehicle 600 that should be thermally controlled. For example, the zones 620 and 622 can be different rows of seats (e.g., a first row versus a second row), or different seats of one row (e.g., a driver seat versus a passenger seat), or different ducting associated with one or more seats (e.g., defrost ducting versus occupant face ducting versus occupant foot ducting). Other approaches can be used.

The controller 612 can link the control of two or more vents of the vehicle 600. In some implementations, the vent mechanisms 602 and 604 are positioned near each other (e.g., at the back of a center console) and the controller 612 can actuate both of the vent mechanisms 602 and 604 to direct their respective airflows toward a common direction (e.g., toward only one of multiple passenger seats in the same row).

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one”.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A vent mechanism comprising:
vent vanes configured to direct airflow from a duct, each of the vent vanes being mounted to the vent mechanism for rotation about respective rotation axes that are parallel with each other;
a ratchet wheel configured to control the rotation of the vent vanes, the ratchet wheel being mounted to the vent mechanism for rotation about a rotation axis that is parallel with the rotation axes of the vent vanes;
a first shape memory alloy wire having a first end and a second end, the first end attached to a first nonmoving portion of the vent mechanism; and
a first moveable member attached to the second end of the first shape memory alloy wire, the first moveable member configured for engaging with at least a first set of teeth of the ratchet wheel to rotate the ratchet wheel in a first direction in response to shortening of the first shape memory alloy wire.

2. The vent mechanism of claim 1, wherein the ratchet wheel is configured to control the rotation of the vent vanes by way of a first vent vane of the vent vanes being attached to the ratchet wheel for rotation with the ratchet wheel, the vent mechanism further including a linkage connected to each of the vent vanes to rotate remaining ones of the vent vanes due to the rotation of the first vent vane.

3. (canceled)

4. (canceled)

5. The vent mechanism of claim 1, wherein the first moveable member includes:
a first arm having a first end and a second end, the first end rotatably attached to a second nonmoving portion of the vent mechanism, the second end attached to the second end of the first shape memory alloy wire; and
a first drive pawl rotatably attached to the first arm, wherein the first drive pawl is configured for engaging with at least the first set of teeth of the ratchet wheel to rotate the ratchet wheel in the first direction in response to shortening of the first shape memory alloy wire.

6. The vent mechanism of claim 5, further comprising a first bias member attached to the first arm, the first bias member biasing the first drive pawl toward the first arm.

7. (canceled)

8. The vent mechanism of claim 5, further comprising a first bias member attached to the second end of the first arm, the first bias member biasing the first arm in a direction opposite to a direction of the shortening of the first shape memory alloy wire.

9. (canceled)

10. The vent mechanism of claim 5, further comprising a detent lock biased toward the ratchet wheel from a third nonmoving portion of the vent mechanism.

11. The vent mechanism of claim 5, further comprising:
a first mechanism coupled to the first drive pawl to release the first drive pawl from the first set of teeth of the ratchet wheel in response to the ratchet wheel reaching an end of rotation;
a locking pawl configured for engaging with at least the first set of teeth of the ratchet wheel;
a second mechanism coupled to the locking pawl to release the locking pawl from the first set of teeth of the ratchet wheel in response to the ratchet wheel reaching the end of rotation; and
a torsion spring configured to rotate the ratchet wheel when the first moveable member and the locking pawl are released from the first set of teeth of the ratchet wheel.

12. The vent mechanism of claim 1, further comprising:
a second shape memory alloy wire having a first end and a second end, the first end attached to a second nonmoving portion of the vent mechanism; and
a second moveable member attached to the second end of the second shape memory alloy wire, the second moveable member configured for engaging with at least a second set of teeth of the ratchet wheel to rotate the ratchet wheel in a second direction in response to shortening of the second shape memory alloy wire, the second direction opposite to the first direction.

13. The vent mechanism of claim 12, wherein the second moveable member includes:
a second arm having a first end and a second end, the first end rotatably attached to a third nonmoving portion of the vent mechanism, the second end attached to the second end of the second shape memory alloy wire; and
a second drive pawl rotatably attached to the second arm, wherein the second drive pawl is configured for engaging with at least the second set of teeth of the ratchet wheel to rotate the ratchet wheel in the second direction in response to shortening of the second shape memory alloy wire.

14. The vent mechanism of claim 13, further comprising a second bias member attached to the second arm, second first bias member biasing the second drive pawl toward the second arm.

15. (canceled)

16. (canceled)

17. The vent mechanism of claim 13, wherein each of the second set of teeth of the ratchet wheel has a driving face to be engaged by the second drive pawl to rotate the ratchet wheel in the second direction, and a nondriving face, and wherein an angle between the driving face and a radius of the ratchet wheel is smaller than an angle between the nondriving face and the radius of the ratchet wheel.

18. The vent mechanism of claim 1, wherein the first moveable member includes:
a first linear actuator having a first end and a second end, the first end attached to the second end of the first shape memory alloy wire, the first linear actuator including first teeth to engage with at least the first set of teeth of the ratchet wheel; and
a first bias member attached to the second end of the first linear actuator and biasing the first linear actuator in a direction opposite to a direction of the shortening of the first shape memory alloy wire.

19. The vent mechanism of claim 18, wherein each of the first teeth of the first linear actuator has a driving face to engage the first set of teeth of the ratchet wheel to rotate the ratchet wheel in the first direction, and a nondriving face, wherein the driving face is perpendicular to a direction of travel of the first linear actuator, and wherein the nondriving face is non-perpendicular to the direction of travel.

20. (canceled)

21. (canceled)

22. The vent mechanism of claim 18, further comprising:
a second shape memory alloy wire having a first end and a second end, the first end attached to a second nonmoving portion of the vent mechanism; and
a second moveable member attached to the second end of the second shape memory alloy wire, the second moveable member configured for engaging with at least a second set of teeth of the ratchet wheel to rotate the ratchet wheel in a second direction in response to shortening of the second shape memory alloy wire, the second direction opposite to the first direction.

23. The vent mechanism of claim 22, wherein the second moveable member includes:
a second linear actuator having a first end and a second end, the first end attached to the second end of the second shape memory alloy wire, the second linear actuator including second teeth to engage with at least the second set of teeth of the ratchet wheel; and
a second bias member attached to the second end of the second linear actuator and biasing the second linear actuator in a direction opposite to a direction of the shortening of the second shape memory alloy wire.

24. The vent mechanism of claim 23, wherein each of the second teeth of the second linear actuator has a driving face to engage the second set of teeth of the ratchet wheel to rotate the ratchet wheel in the second direction, and a nondriving face, wherein the driving face is perpendicular to a direction of travel of the second linear actuator, and wherein the nondriving face is non-perpendicular to the direction of travel.

25. The vent mechanism of claim 24, wherein each of the second set of teeth of the ratchet wheel has a driving face to be engaged by the second teeth of the second linear actuator to rotate the ratchet wheel in the second direction, and a nondriving face, and wherein an angle between the driving face and a radius of the ratchet wheel is equal to an angle between the nondriving face and the radius of the ratchet wheel.

26. The vent mechanism of claim 23, wherein each of the second set of teeth of the ratchet wheel has a driving face to be engaged by the second teeth of the second linear actuator to rotate the ratchet wheel in the second direction, and a nondriving face, and wherein an angle between the driving face and a radius of the ratchet wheel is smaller than an angle between the nondriving face and the radius of the ratchet wheel.

27. The vent mechanism of claim 18, further comprising a detent lock biased toward the first set of teeth of the ratchet wheel from a third nonmoving portion of the vent mechanism.

28. The vent mechanism of claim 18, further comprising:
a locking pawl configured for engaging with at least the first set of teeth of the ratchet wheel;
a mechanism coupled to the locking pawl to release the locking pawl from the first set of teeth of the ratchet wheel in response to the ratchet wheel reaching an end of rotation; and
a torsion spring configured to rotate the ratchet wheel when the first moveable member and the locking pawl are released from the first set of teeth of the ratchet wheel.

29. (canceled)

30. (canceled)

31. (canceled)

32. (canceled)

33. (canceled)

34. (canceled)

35. (canceled)

36. (canceled)

37. (canceled)
